(19) United States
(12) Patent Application Publication
(10) Pub. No.: US 2026/0011779 A1
(43) Pub. Date: Jan. 8, 2026

(54) Manufacturing Process of Lithium Trifluoro (Nitrato) Borate as An Additive For Lithium-Ion Secondary Cells, An Electrolyte And Lithium-Ion Secondary Cells

(71) Applicants: Gotion, Inc., Independence, OH (US); University of Rhode Island Board of Trustees, Kingston, RI (US)

(72) Inventors: Martin Payne, Avon, OH (US); Jennifer Hoffmann, North Royalton, OH (US); Brett Lucht, Kingston, RI (US); Venkata A.K. Adiraju, Warwick, RI (US); Chamithri Jayawardana, Providence, RI (US); Nuwanthi D Rodrigo, Kingston, RI (US)

(73) Assignees: Gotion, Inc., Independence, OH (US); University of Rhode Island Board of Trustees, Kingston, RI (US)

(21) Appl. No.: 18/765,075

(22) Filed: Jul. 5, 2024

(51) Int. Cl. H01M 10/0567; H01M 10/0525; H01M 10/0569

(52) U.S. Cl. CPC H01M 10/0567; H01M 10/0525; H01M 10/0569; H01M 2300/0028

(57) ABSTRACT

Method of manufacturing lithium trifluoro(nitrato) borate as an additive for lithium-ion secondary cells, including, a) at room temperature, adding boron trifluoride complex dropwise to a solution of lithium nitrate in methanol to form a first solution, stirring the first solution overnight and removing volatile solvents in vacuo to obtain a first solid product; b) dissolving the first solid product in ester solvent, adding toluene to form a second solution, stirring the second solution overnight to obtain a white precipitate; c) decanting solvents in the second solution, drying the white precipitate in vacuo to obtain lithium trifluoro(nitrato) borate as the additive for lithium-ion secondary cells. Further disclosed is an electrolyte containing the above prepared lithium trifluoro(nitrato) borate and lithium-ion secondary cells using the electrolytes. The addition lithium trifluoro(nitrato) borate in the electrolytes may, for example, improve specific capacity of the cell and maintain an efficiency of over 85% after 100 cycles.

### TECHNICAL FIELD

The present invention relates to the field of cells, in particular to a manufacturing process of lithium trifluoro(nitrato) borate as an additive for lithium-ion secondary cells, an electrolyte comprising lithium trifluoro(nitrato) borate and lithium-ion secondary cells with the electrolyte.

### BACKGROUND

Increasing adoption of EV is likely to significantly drive growth of the battery electrolyte market in the coming years. Various electrolyte additives have been reported as being able to improve the properties such as stability of the solid electrolyte interphase (SEI) layer on the electrode surfaces. SEIs generated using electrolyte additives are key for anode-electrolyte interactions and for enhancing the Li-ion battery lifespan. More specifically, electrolyte additives improve the ionic conductivity of the electrolyte, thermal stability of electrolyte, safety of the battery, and enable cathode material protection from degradation, etc. Efforts have been continuing in developing new synthetic additives that allows to form a highly stable electrode-electrolyte interface architecture from the electrolyte additives and to endure facile Li-ion transport while protecting the lithium-ion cathodes.

For example, US2018048025A1 discloses electrolytes for use in commercially viable, rechargeable lithium metal cells. The electrolytes contain one or more lithium salts, one or more organic solvents, and one or more additives. The additives include pyrrolidones, sulfonimides, carbodimides, sulfonyl fluorides, fluoroacetates, silanes, cyano-silanes, triflate, organo-borates, nitriles, or isocyanates. Suitable additives include 1-ethyl-2-pyrrolidone (NEP), N-fluorobenzenesulfonimide (FBSI), bis (alkyl)- or bis (aryl) carbodiimides, allyl trifluoroacetate, vinyltrimethylsilane, tetra(isocyanato) silane, carbon dioxide, LiBSB, LiOTf, perfluorobutanesulfonyl fluoride (PFBS-F), LiPFBS, lithium vinyltrifluoroborate, aryl nitriles (particularly any of a number of substituted benzonitriles), alkyl-or aryl-isocyanates, examples of which include ethyl-, pentyl-, dodecyl-, and 4-fluorophenyl-isocyanate.

For another example, US2011/0136019A1 relates to lithium-ion secondary cells including cathode active materials that are capable of operation at high voltages with correspondingly appropriate electrolytes suitable for longer term cycling. The desired electrolytes generally comprise ethylene carbonate and a liquid solvent along with a stabilizing additive. Some stabilizing additives are lithium salts, and other desirable stabilizing additives are organic compositions.

For yet another example, US2016/0372789A1 discloses electrolyte formulations including additives or combinations of additives that provide low temperature performance and high temperature stability in lithium-ion battery cells. The electrolyte formulations include a lithium salt, an organic solvent, and an additive. The additive includes a boron-containing compound selected from the group consisting of diborons and borates.

### SUMMARY

The present invention relates to a new electrolyte additive containing lithium nitrate complex with a borate. The cycle performance of lithium-ion secondary cells is shown to improve with the additive when compared to the standard electrolyte.

In one aspect, the present invention provides a manufacturing method of lithium trifluoro(nitrato) borate as an additive for lithium-ion secondary cells, comprising the steps of,
a) at room temperature, adding boron trifluoride complex dropwise to a solution of lithium nitrate in methanol to form a first solution, stirring the first solution overnight and removing volatile solvents in vacuo to obtain a first solid product;
b) dissolving the first solid product in ester solvent, then adding toluene to form a second solution, stirring the second solution overnight to obtain a white precipitate;
c) decanting solvents in the second solution, drying the white precipitate in vacuo to obtain lithium trifluoro(nitrato) borate as the additive for lithium-ion secondary cells.

“Volatile solvents” state for solvents that evaporates at about 25 to 30° C. at standard atmospheric pressure.

Preferably, the ester solvent is a carbonate ester solvent. Specifically, it can be at least one of dimethyl carbonate, diethyl carbonate, ethylene carbonate, dipropyl carbonate, methyl ethyl carbonate, methyl propyl carbonate or ethyl propyl carbonate.

Preferably, the boron trifluoride complex is selected from formula (i) or formula (ii) below, or combinations thereof,

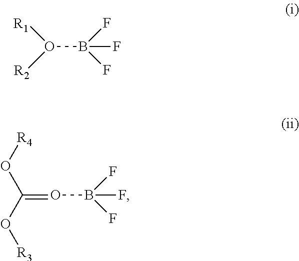

wherein in formula (i), R₁ and R₂ are independently selected from anyone of C₁ to C₅₀ alkyl groups, C₃ to C₅₀ cycloalkyl groups, C₂ to C₅₀ alkenyl groups, or C₆ to C₅₀ aryl groups; wherein hydrogen atoms in R₁ and R₂ are optionally substituted, or R₁ and R₂ form saturated or unsaturated rings with hydrogen atoms on the rings being optionally substituted,
wherein in formula (ii), R₃ and R₄ are independently selected from anyone of C₁ to C₅₀ alkyl groups, C₃ to C₅₀ cycloalkyl groups, C₂ to C₅₀ alkenyl groups, or C₆ to C₅₀ aryl groups; wherein hydrogen atoms in R₃ and R₄ are optionally substituted.

Preferably, the boron trifluoride complex comprises boron trifluoride ether complex, boron trifluoride dimethyl carbonate complex, boron trifluoride diethyl carbonate complex, boron trifluoride methyl ethyl carbonate complex, or combinations thereof.

Preferably, the boron trifluoride complex and the lithium nitrate has a molar ratio of 1:0.5 to 1:1.5, more preferably 1:1.

In another aspect, the present invention further provides an electrolyte for lithium-ion secondary cells, comprising lithium trifluoro(nitrato) borate manufactured according to the above methods as an additive.

Preferably, the electrolyte contains 0.1wt %˜1 wt %, preferably 0.1wt %˜0.5 wt % of lithium trifluoro(nitrato) borate.

Preferably, the electrolyte contains at least one of dimethyl carbonate (DMC), diethyl carbonate (DEC), ethylene carbonate (EC), methyl ethyl carbonate (EMC), 3-pyridneboronic acid, 1,3-propanediol ester (PBAPDE), and lithium difluoro (oxalato) borate (LiDFOB).

In yet another aspect, the present invention provides a lithium-ion secondary cell, comprising the electrolyte according to the above.

Preferably, the lithium-ion secondary cell is an NCM cell, a LMNO cell, or an NCA cell.

“NCM cells” state for cells using cathode materials having a general formula of Li[NiₓCo_{y}Mn_{z}]O₂. Depending on the ratio among x, y and z, there are mainly three kinds of NCM cells, NCM532 with a x:y:z ratio of 5:3:2, NCM622 with a x:y:z ratio of 6:2:2, and NCM811 with a x:y:z ratio of 8:1:1.

“LMNO cells” state for cells using cathode materials having a general formula of LiMn₂₋ₓNiₓO₄ (with x≤0.5). Typically, LiNi0.5Mn1.5O4 and LiNi0.8Mn0.1Co0.1O2 are suitable materials for cathode of LMNO cells.

“NCA cells” state for cells using cathode materials having a general formula of LiNi1-x-yAlxCoyO2. Typically, LiNi0.8Al0.05Co0.15O2 is a suitable material for cathode of NCA cells.

Generally, the anode materials used in the cells mentioned above are graphite or lithium. Depending on the anode materials, cells can be also referred to as “full-cell” (graphite) or “half-cell” (lithium), respectively.

The lithium trifluoro(nitrato) borate prepared according to the above method in the present invention can be well dissolved in the electrolyte used for lithium-ion secondary cells when added in an appropriate amount, forming a stable SEI film during the cell formation process, thereby improving the specific capacity of the cell and maintain an efficiency of over 85% after 100 cycles.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a ¹¹B{¹H}NMR (128 MHz, acetone-d₆) spectrum of lithium trifluoro(nitrato) borate prepared by an exemplary manufacturing process of the present invention.

FIG. 2 is a ¹⁹F NMR (376 MHz, acetone-d₆) spectrum of lithium trifluoro(nitrato) borate prepared by an exemplary manufacturing process of the present invention.

FIG. 3 is an ATR-IR spectrum of lithium trifluoro(nitrato) borate prepared by an exemplary manufacturing process of the present invention.

FIG. 4 is a graph comparing the specific capacities at 25° C. (RT) of the LMNO/C pouch cells using different electrolytes.

FIG. 5 is a graph comparing the specific capacities at 45° C. of the LMNO/C pouch cells using electrolytes with or without lithium trifluoro(nitrato) borate prepared by an exemplary manufacturing process of the present invention.

FIG. 6 is a graph comparing the retention or efficiency at 25° C. of the LMNO/C pouch cells using electrolytes with or without lithium trifluoro(nitrato) borate prepared by an exemplary manufacturing process of the present invention.

FIG. 7 is a graph comparing the specific capacities at 25° C. of the LMNO/Li coin cells using different electrolytes.

FIG. 8 is a graph comparing the retention or efficiency at 25° C. of the LMNO/Li coin cells using different electrolytes.

FIG. 9 is a graph comparing the specific capacities at 25° C. and 45° C. of the NCM811/Li coin cells using electrolytes with or without lithium trifluoro(nitrato) borate prepared by an exemplary manufacturing process of the present invention.

FIG. 10 is a graph characterizing the efficiency at 25° C. and 45° C. of the NCM811/Li coin cells using electrolytes with or without lithium trifluoro(nitrato) borate prepared by an exemplary manufacturing process of the present invention.

FIG. 11 is a graph comparing the specific capacities at 25°° C. of the NCM712/C coin cells using electrolytes with or without lithium trifluoro(nitrato) borate prepared by an exemplary manufacturing process of the present invention.

FIG. 12 is a graph comparing the retention or efficiency at 25° C. of the NCM712/C coin cells using electrolytes with or without lithium trifluoro(nitrato) borate prepared by an exemplary manufacturing process of the present invention.

### DETAILED DESCRIPTION

The present invention will be further illustrated below in combination with examples and the accompanying drawings. Those examples are merely used for describing the optimal implementation modes of the present invention, but not intended to make any limitation to the scope of the present invention.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”. and “the” include plural references unless the context clearly dictates otherwise. The term “at least one of” in the context of, e.g., “at least one of A, B, and C” refers to only A, only B, only C, or any combination of A, B, and C.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Chemical elements are discussed in the present disclosure using their common chemical abbreviation, such as commonly found on a periodic table of elements. For example, hydrogen is represented by its common chemical abbreviation H; boron is represented by its common chemical abbreviation B; and so forth.

### I. Determination Methods

¹H, ¹¹B, and ¹⁹F NMR spectra were recorded on a BRUKER ASCEND 400 MHz spectrometer following standard methods aligned with the manufacturers operating procedures.

IR-ATR spectra were recorded on a BRUKER TENSOR 27 spectrometer equipped with a diamond crystal on solid sample, following standard methods aligned with the manufacturers operating procedures.

Specific capacity and efficiency of the cells are tested by ARBIN LBT21084 high precision battery cycler.

Various chemicals and materials used in Examples and Comparative examples are collectively shown below.
Ethylene carbonate (EC), manufactured by BASF;
Ethyl methyl carbonate (EMC), manufactured by BASF;
Lithium Nickel Manganese Cobalt Oxide (LiNi_{0.8}Mn_{0.1}Co_{0.1}O₂) electrodes, supplied by BASF;
Lithium Manganese Nickel oxide (LiNi_{0.5}Mn_{1.5}O₄) electrodes, supplied by BORMAN MATERIALS;
Li metal chips, manufactured by MTI cooperation;
Graphite electrode, purchased from SIGMA-ALDRICH.

The other chemicals mentioned below were purchased from SIGMA-ALDRICH and used as received.

### II. Manufacturing Process of the Additive

### Example 1

The present example provides an exemplary method for synthesis of lithium trifluoro (nitrato) borate (LiLBN) according to the present disclosure.

In this Example, the molar ratio between boron trifluoride complex and lithium nitrate is 1:1.

At room temperature, boron trifluoride diethyl ether (2 mL,7.54 mmol) was added dropwise and slowly to a solution of lithium nitrate (519.5 mg, 7.54 mmol) in methanol. The solution was stirred overnight and then the volatile solvents were removed in vacuo. The residue solids were dissolved in dimethyl carbonate (2 mL) and to the solution toluene (4 mL) was added. The obtained mixture was stirred overnight resulting in a white precipitate. The solvent was decanted, and precipitate was dried overnight in vacuo to obtain white powder. Yield: 620.0 mg, 60%.

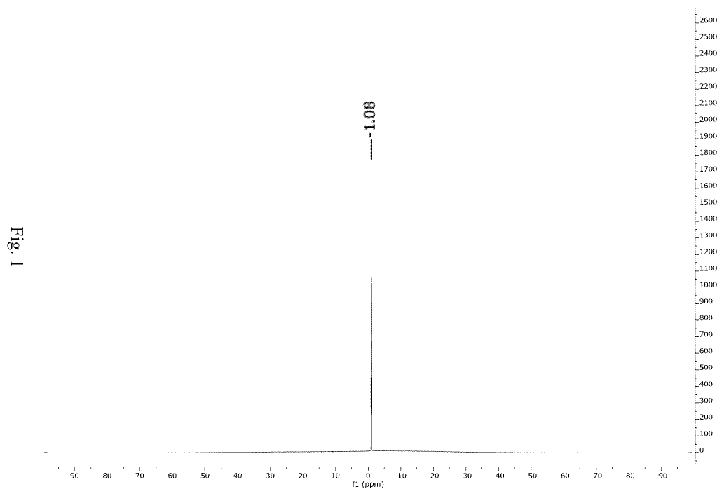

FIG. 1 showed a ¹¹B{¹H}NMR (128 MHz, acetone-d₆) spectrum of the lithium trifluoro(nitrato) borate prepared by Example 1, which revealed a peak at −1.1 ppm, indicating the BF3 chemical shift.

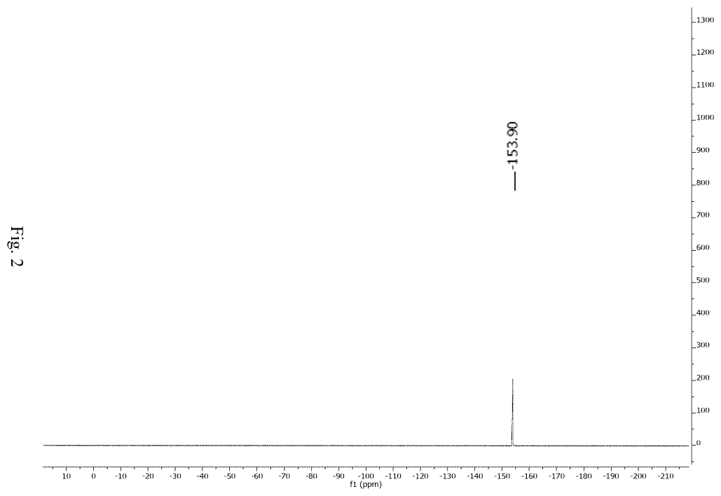

FIG. 2 showed a ¹⁹F NMR (376 MHz, acetone-d₆) spectrum of the lithium trifluoro(nitrato) borate prepared by Example 1, which revealed a peak at −153.90 ppm, also indicating a chemical shift associated with the presence of BF3.

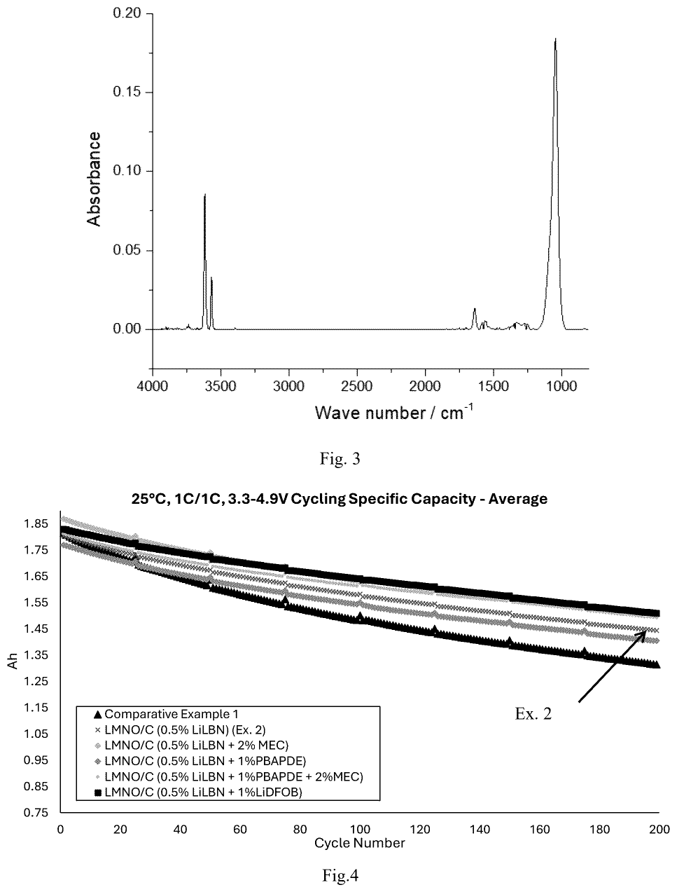

FIG. 3 showed an ATR-IR spectrum of the lithium trifluoro(nitrato) borate prepared by Example 1, which showed three peaks at around 1021 cm⁻¹, 1316 cm⁻¹ and 1640 cm⁻¹, indicating the structure of B—F, N—O and B—O.

The analysis above illustrates that the additive lithium trifluoro(nitrato) borate was synthesized in Example 1. Ideally, the synthesis process followed the following scheme:

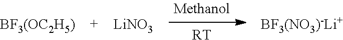

### Example 2

The present example provides an exemplary construction of LMNO/C pouch cell using an electrolyte containing the additive lithium trifluoro(nitrato) borate (LiBF₃NO₃) according to the present disclosure.

0.5% weight percent of LiBF₃NO₃ was added to the standard electrolyte (referred to as STD, 1.2M LiPF₆ in ethylene carbonate (EC):ethyl methyl carbonate (EMC), 20:80 by volume percent) in an Argon filled glovebox. Lithium Nickel Manganese Oxide (LiNi_{0.5}Mn_{1.5}O₄) electrodes with a 97.5% active material content were dried in a vacuum oven at 120° C. for 24 hours before cell construction.

Pouch cells were hand assembled using 17-40.5×115.5 mm anode pieces and 16-40.0×113.5 mm cathode electrodes, assembled in a Z-fold fashion separated by two layers of a PE separator. The stack was sealed in a foil pouch. The stacked cell had an overall capacity of 2 Ah.

After the construction of the pouch cell, the specific capacities of the pouch cells were tested at 3.3-4.9V at 25° C. and 45° C. Total number of the cycles done at 25° C. and 45° C. were both about 200.

### Example 3

The present example provides an exemplary construction of LMNO half coin cell using an electrolyte containing the additive lithium trifluoro(nitrato) borate (LiBF₃NO₃) according to the present disclosure.

1% weight percent of LiBF₃NO₃ was added to the standard electrolyte (referred to as STD, 1.2M LiPF₆ in ethylene carbonate (EC):ethyl methyl carbonate (EMC), 20:80 by volume percent) in an Argon filled glovebox. Lithium Nickel Manganese Oxide (LiNi_{0.5}Mn_{1.5}O₄) electrodes with a 97.5% active material content were dried in a vacuum oven at 120° C. for 24 hours before cell construction. Then, 2032 type coin cells were constructed with inside the Argon glovebox with water content ≤0.1 ppm. Specifically, two-electrode configuration coin cells were constructed with 13.7 mm LMNO working electrode, three separators (two CELGARD 2325 and one WHATMAN GF/D glass fiber), a 16 mm lithium chip counter electrode, and 100 μL of the electrolyte. The LMNO/Li cells were formation-cycled using galvanostatically cycling within a voltage range of 3.3-4.8 V vs Li/Li⁺ with a current density corresponding to C/20 in the first cycle and C/10 in the second and third cycles at 25° C. After formation cycling, cells were tested at the same voltage range at a rate of C/5 at 25. Total number of the cycles done at 25° C. was about 60.

### Example 4

The cell construction in Example 4 is similar to Example 3, with the difference that the standard electrolyte is 1.2M LiPF₆ in ethylene carbonate (EC):ethyl methyl carbonate (EMC):fluoroethylene carbonate (FEC) of 20:60:15 by volume percent, and the amount of LiBF₃NO₃ was 0.5% weight percent. Here, FEC was used as a solvent.

### Example 5

The present example provides an exemplary construction of NCM811 half coin cell using an electrolyte containing the additive lithium trifluoro(nitrato) borate (LiBF₃NO₃) according to the present disclosure.

0.5% weight percent of LiBF₃NO₃ was added to the standard electrolyte (referred to as STD, 1.2M LiPF₆ in ethylene carbonate (EC):ethyl methyl carbonate (EMC), 20:80 by volume percent) in an Argon filled glovebox. Lithium Nickel Manganese Cobalt Oxide (LiNi_{0.8}Mn_{0.1}Co_{0.1}O₂) electrodes with a 97.5% active material content were dried in a vacuum oven at 120° C. for 24 hours before cell construction. Then, 2032 type coin cells were constructed with inside the Argon glovebox with water content ≤0.1 ppm. Specifically, two-electrode configuration coin cells were constructed with 13.7 mm NCM 811 working electrode, three separators (two CELGARD 2325 and one WHATMAN GF/D glass fiber), a 16 mm lithium chip counter electrode, and 100 μL of electrolyte. The NCM811/Li cells were formation-cycled using galvanostatically cycling within a voltage range of 3-4.5 V vs Li/Li⁺ with a current density corresponding to C/20 in the first cycle and C/10 in the second and third cycles at 25° C. After formation cycling, cells were tested at the same voltage range at a rate of C/5 at 25° C. and 45° C. Total number of cycles done at 25° C. and 45° C. were both about 60.

### Example 6

The present example provides an exemplary construction of NCM712 full coin cell using an electrolyte containing the additive lithium trifluoro(nitrato) borate (LiBF₃NO₃) according to the present disclosure.

0.1% weight percent of LiBF₃NO₃ was added to the standard electrolyte (referred to as STD, 1.2M LiPF₆ in ethylene carbonate (EC):Ethyl methyl carbonate (EMC), 20:80 by volume percent) in an Argon filled glovebox. Lithium Nickel Manganese Cobalt Oxide (LiNi_{0.8}Mn_{0.1}Co_{0.1}O₂) electrodes with a 97.5% active material content were dried in a vacuum oven at 120° C. for 24 hours before cell construction. Then, the full-cells were constructed with inside the Argon glovebox with water content ≤0.1 ppm. Specifically, two-electrode configuration coin cells were constructed with 13.7 mm NCM 811 working electrode, three separators (two CELGARD 2325 and one WHATMAN GF/D glass fiber), a 16 mm graphite rod counter electrode, and 100 μL of electrolyte. The NCM811/C cells were formation-cycled using galvanostatically cycling within a voltage range of 2.7-4.2 V vs Li/Li⁺ with a current density corresponding to C/20 in the first cycle and C/10 in the second and third cycles at 25° C. After formation cycling, cells were tested at the same voltage range at a rate of C/5 at 25° C. Total number of cycles done at 25° C. was about 100.

### Comparative Example 1

The cell construction in Comparative Example 1 is similar to Example 2, with the difference that the electrolyte does not contain LiBF₃NO₃.

### Comparative Example 2

The cell construction in Comparative Example 2 is similar to Example 3, with the difference that the electrolyte does not contain LiBF₃NO₃.

### Comparative Example 3

The cell construction in Comparative Example 3 is similar to Example 5, with the difference that the electrolyte does not contain LiBF₃NO₃.

### Comparative Example 4

The cell construction in Comparative Example 4 is similar to Example 6, with the difference that the electrolyte does not contain LiBF₃NO₃.

The features of the cells in Examples 2-6 and Comparative Examples 1-4 are listed in Table 1 as follows.

TABLE 1

| | | Amount of | |
|---|---|---|---|
| | Electrode | LiLBN | Electrolyte system |
| No. | system | (wt %) | (Volume percent) |
| Example 2 | LMNO/C | 0.5 | EC:EMC |
| | pouch | | 20:80 |
| Example 3 | LMNO/Li | 1 | EC:EMC |
| | coin | | 20:80 |
| Example 4 | LMNO/Li | 0.5 | EC:EMC:FEC |
| | coin | | 20:60:15 |
| Example 5 | NCM811/Li | 0.5 | EC:EMC |
| | coin | | 20:80 |
| Example 6 | NCM811/C | 0.1 | EC:EMC |
| | coin | | 20:80 |
| Comparative | LMNO/C | None | EC:EMC |
| Example 1 | pouch | | 20:80 |
| Comparative | LMNO/Li | None | EC:EMC |
| Example 2 | coin | | 20:80 |
| Comparative | NCM811/Li | None | EC:EMC |
| Example 3 | coin | | 20:80 |
| Comparative | NCM811/C | None | EC:EMC |
| Example 4 | coin | | 20:80 |

Referring to FIG. 4, the specific capacities at 25° C. of the LMNO/C pouch cells using different electrolytes were shown. Those graphs indicating electrolytes containing other URI additives such as MEC, PBAPDE, and LiDFOB along with LiLBN are used to illustrate the compatibility of LiLBN with other additives. Moreover, 0.5 wt % of LiLBN in a common electrolyte system can already improve the specific capacity of the LMNO/C pouch cell. Similarly, referring to FIG. 5, at 45° C., the specific capacities of the LMNO/C pouch cells showed a trend similar to those at 25° C., which means that the specific capacities were also improved.

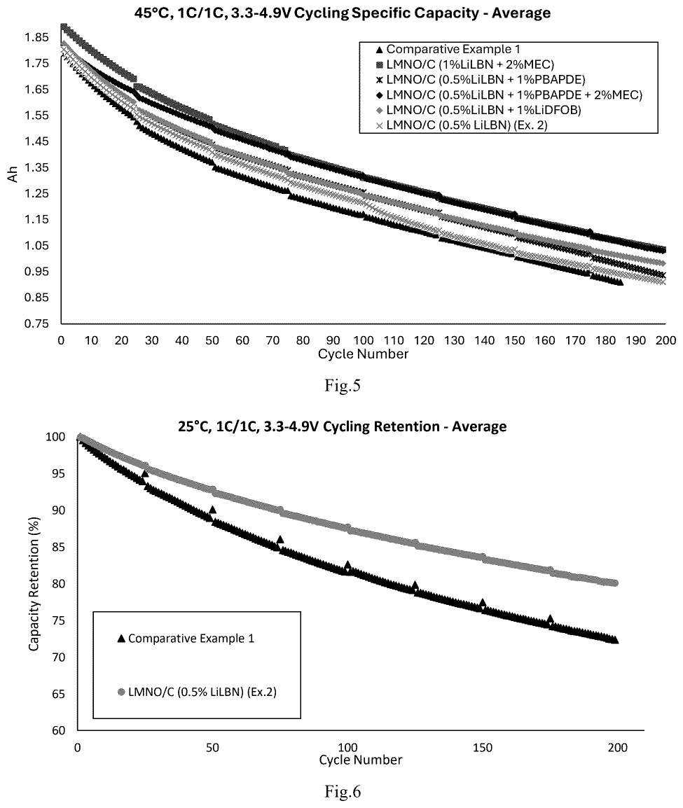

Referring to FIG. 6, it can be seen that the retention or efficiency at 25° C. of the LMNO/C pouch cells using electrolytes containing 0.5 wt % of LiLBN can be improved by 7.8%, comparing with the electrolyte that does not contain LiLBN. Moreover, although not shown, the electrolyte containing other URI additives along with LiLBN also have similar retention trend as the electrolyte that contains LiLBN only.

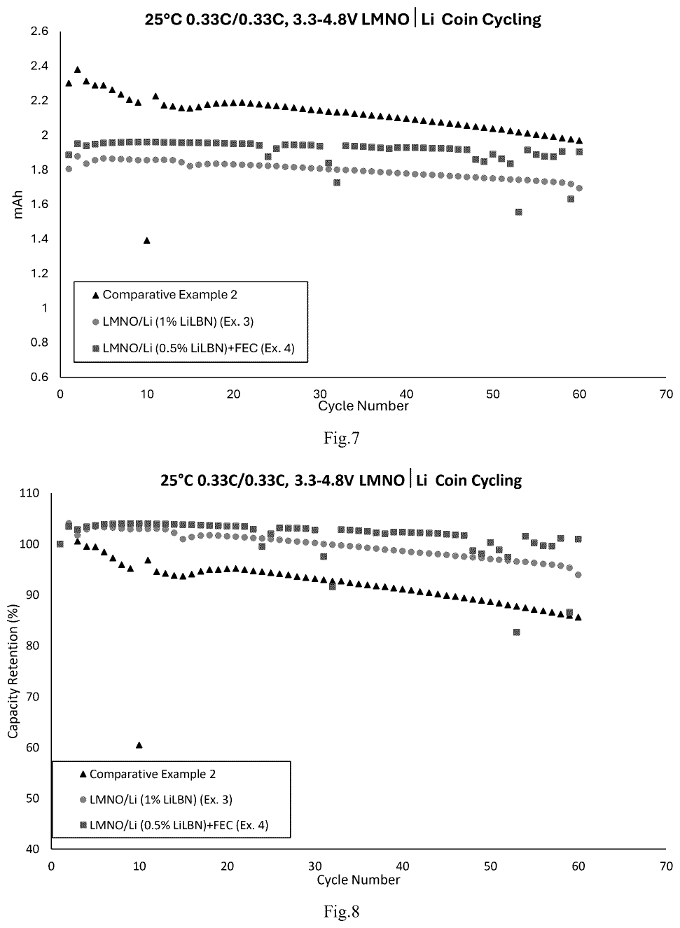

Referring to FIG. 7 and FIG. 8, it can be seen that although the specific capacities of LMNO/Li coin cells were not improved, the retentions of the cells containing electrolytes with LiLBN were more stable than those without LiLBN.

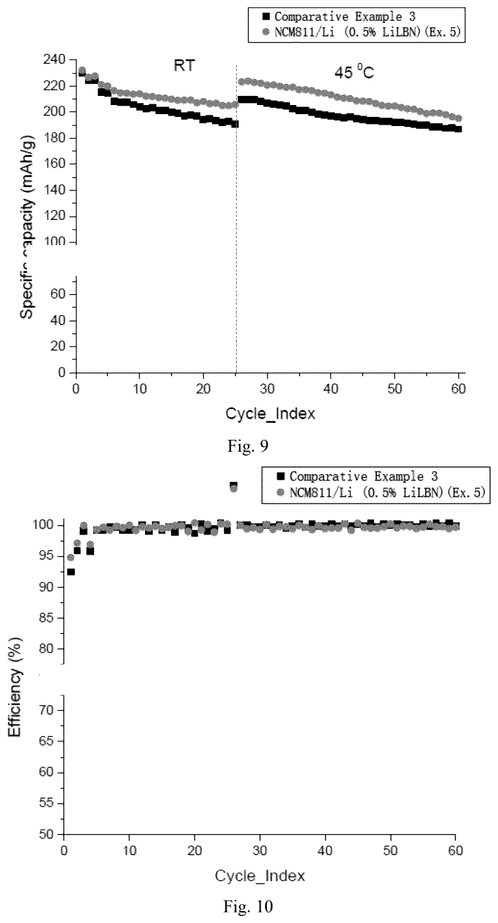

Referring to FIG. 9 and FIG. 10, it can be seen that the specific capacities at 25° C. and 45° C. of the NCM811/Li coin cells using electrolytes containing 0.5 wt % of LiLBN were both improved comparing to those without LiLBN. Moreover, the retention of the NCM811/Li coin cells using electrolytes containing LiLBN were also similar to those without LiLBN, which indicates that LiLBN is an ideal electrolyte additive for performance improvement of lithium-ion battery at both room temperature and high temperature.

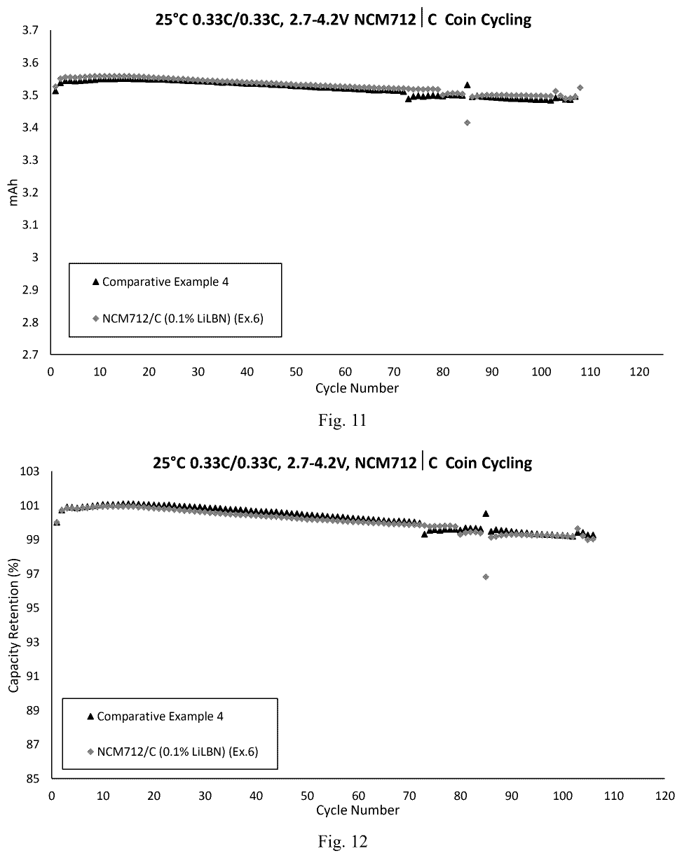

Referring to FIG. 11 and FIG. 12, it can be seen that for NCM712/C coin cells, even a small amount of 0.1 wt % of LiLBN in the electrolyte can improve the specific capacity at 25° C., while the cell retention remains almost the same, which also indicates that LiLBN is a suitable electrolyte additive for performance improvement of NCM712/C coin cell.

This written description uses examples to disclose the present technology, including the best mode, and also to enable any person skilled in the art to practice the present technology, including making and using any devices or systems and performing any incorporated methods. The patentable scope of the present technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A manufacturing method of lithium trifluoro(nitrato) borate as an additive for lithium-ion secondary cells, comprising the steps of,
a) at room temperature, adding boron trifluoride complex dropwise to a solution of lithium nitrate in methanol to form a first solution, stirring the first solution overnight and removing volatile solvents in vacuo to obtain a first solid product;
b) dissolving the first solid product in ester solvent, then adding toluene to form a second solution, stirring the second solution overnight to obtain a white precipitate;
c) decanting solvents in the second solution, drying the white precipitate in vacuo to obtain lithium trifluoro(nitrato) borate as the additive for lithium-ion secondary cells.

2. The manufacturing method according to claim 1, wherein the ester solvent is at least one of dimethyl carbonate, diethyl carbonate, ethylene carbonate, dipropyl carbonate, methyl ethyl carbonate, methyl propyl carbonate or ethyl propyl carbonate.

3. The manufacturing method according to claim 1, wherein the boron trifluoride complex is selected from formula (i) or formula (ii) below, or combinations thereof, 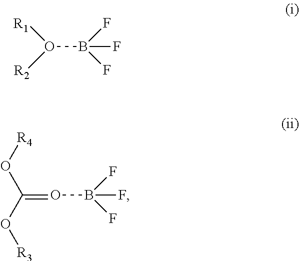
wherein in formula (i), R₁ and R₂ are independently selected from anyone of C₁ to C₅₀ alkyl groups, C₃ to C₅₀ cycloalkyl groups, C₂ to C₅₀ alkenyl groups, or C₆ to C₅₀ aryl groups; wherein hydrogen atoms in R₁ and R₂ are optionally substituted, or R₁ and R₂ form saturated or unsaturated rings with hydrogen atoms on the rings being optionally substituted, wherein in formula (ii), R₃ and R₄ are independently selected from anyone of C₁ to C₅₀ alkyl groups, C₃ to C₅₀ cycloalkyl groups, C₂ to C₅₀ alkenyl groups, or C₆ to C₅₀ aryl groups;
wherein hydrogen atoms in R₃ and R₄ are optionally substituted.

4. The manufacturing method according to claim 1, wherein the boron trifluoride complex comprises boron trifluoride ether complex, boron trifluoride dimethyl carbonate complex, boron trifluoride diethyl carbonate complex, boron trifluoride methyl ethyl carbonate complex, or combinations thereof.

5. The manufacturing method according to claim 1, wherein the boron trifluoride complex and the lithium nitrate has a molar ratio of 1:0.5 to 1:1.5, preferably 1:1.

6. An electrolyte for lithium-ion secondary cells, comprising lithium trifluoro(nitrato) borate manufactured according to claim 1 as an additive.

7. The electrolyte according to claim 6, wherein the electrolyte contains 0.1 wt %˜1 wt %, preferably 0.1 wt %˜0.5 wt % of lithium trifluoro(nitrato) borate.

8. A lithium-ion secondary cell, comprising the electrolyte according to claim 7.

9. The lithium-ion secondary cell according to claim 8, wherein the lithium-ion secondary cell is an NCM cell, a LMNO cell, or an NCA cell.

10. The electrolyte according to claim 6, wherein the electrolyte contains at least one of dimethyl carbonate (DMC), diethyl carbonate (DEC), ethylene carbonate (EC), methyl ethyl carbonate (EMC), 3-pyridneboronic acid, 1,3-propanediol ester (PBAPDE), and lithium difluoro (oxalato)borate (LiDFOB).

11. A lithium-ion secondary cell, comprising the electrolyte according to claim 10.

12. The lithium-ion secondary cell according to claim 11, wherein the lithium-ion secondary cell is an NCM cell, a LMNO cell, or an NCA cell.

13. A lithium-ion secondary cell, comprising the electrolyte according to claim 6.

14. The lithium-ion secondary cell according to claim 13, wherein the lithium-ion secondary cell is an NCM cell, a LMNO cell, or an NCA cell.
